(19) United States
(12) Patent Application Publication
(10) Pub. No.: US 2024/0185173 A1
(43) Pub. Date: Jun. 6, 2024

(54) SYSTEM AND METHOD FOR AUTOMATED COORDINATION OF PICKUP AND DELIVERY OF LAUNDRY SERVICES

(71) Applicant: TECHTREX INC., Etobicoke (CA)

(72) Inventors: Charles LEE, Etobicoke (CA); Victor CHAN, Etobicoke (CA); Gurpreet SINGH, Etobicoke (CA)

(21) Appl. No.: 18/526,043

(22) Filed: Dec. 1, 2023

Related U.S. Application Data
(60) Provisional application No. 63/385,895, filed on Dec. 2, 2022.

(51) Int. Cl. G06Q 10/0835; G06Q 10/0631; G06Q 30/0283

(52) U.S. Cl. CPC G06Q 10/0835; G06Q 10/063114; G06Q 30/0283

(57) ABSTRACT

There is provided a system and method for automated coordination of pickup and delivery of laundry services for laundering articles at a self-service laundromat. The method includes receiving a service request from a client terminal, the service request including a laundry pickup address and a laundry delivery address; determining a delivery person to respond to the service request; directing the delivery person to pickup the articles to be laundered; receiving a status from a laundry machine terminal associated with a laundry machine subsequent to the delivery person loading the articles to be laundered into the laundry machine; directing the delivery person to collect the laundered articles by communicating the status of the laundry cleaning to the delivery personnel terminal when the status indicates the cleaning is complete; and directing the delivery person to deliver the laundered articles.

### TECHNICAL FIELD

The following generally relates to automated coordination of services, and more specifically, to a method and system for automated coordination of pickup and delivery of laundry services between laundromats, customers, and delivery personnel.

### BACKGROUND

Household-related duties of performing laundry-related tasks are generally time-consuming and labour-demanding, even with advanced laundry appliances. Even with the development of laundry machines and other laundry-related technologies, laundry is a time-consuming and unappealing task. Even more so for many consumers who are without access to such appliances, and often use self-service laundromats to complete laundry tasks.

### SUMMARY

In an aspect, there is provided a method automated coordination of pickup and delivery of laundry services for laundering articles at a self-service laundromat, the method comprising: receiving a service request from a client terminal, the service request comprising a laundry pickup address and a laundry delivery address; determining a delivery person to respond to the service request; directing the delivery person to pickup the articles to be laundered by communicating the service request to a delivery personnel terminal associated with the delivery person; receiving a status from a laundry machine terminal associated with a laundry machine subsequent to the delivery person loading the articles to be laundered into the laundry machine; directing the delivery person to collect the laundered articles by communicating the status of the laundry cleaning to the delivery personnel terminal when the status indicates the cleaning is complete; and directing the delivery person to deliver the laundered articles to the laundry delivery address.

In a particular case of the method, the method further comprising receiving a further service request, and wherein while the laundry machine is operating, communicating the further service request to the delivery person.

In another case of the method, the delivery personnel terminal comprises a video recording device to records images or videos of the pickup of the articles to be laundered, operation of the laundry machine, and delivery of the articles to be laundered.

In yet another case of the method, the method further comprising receiving a status from the laundry machine terminal associated with a dryer subsequent to the delivery person loading the articles to be laundered into the dryer.

In yet another case of the method, the service request comprises a selected wash mode, and wherein directing the delivery person to launder the articles comprises indicating the selected wash mode.

In yet another case of the method, the service request further comprises directions to the delivery person to iron, fold, pack, or a combination thereof, the articles.

In yet another case of the method, the method further comprising predicting demand of the laundry machines at the self-service laundromat using a predictive model, and adjusting a pricing for the service request based on the predicted demand.

In another aspect, there is provided a system for automated coordination of pickup and delivery of laundry services for laundering articles at a self-service laundromat, the system comprising a server terminal, a client terminal, a laundry machine terminal, and a delivery personnel terminal, each terminal comprising one or more processors in communication with a data storage, the data storage of the server terminal comprising instructions for the one or more processors to execute: receiving a service request from a client terminal, the service request comprising a laundry pickup address and a laundry delivery address; determining a delivery person to respond to the service request; directing the delivery person to pickup the articles to be laundered by communicating the service request to a delivery personnel terminal associated with the delivery person; receiving a status from a laundry machine terminal associated with a laundry machine subsequent to the delivery person loading the articles to be laundered into the laundry machine; directing the delivery person to collect the laundered articles by communicating the status of the laundry cleaning to the delivery personnel terminal when the status indicates the cleaning is complete; and directing the delivery person to deliver the laundered articles to the laundry delivery address.

In a particular case of the system, the system further receives a further service request, and wherein while the laundry machine is operating, communicates the further service request to the delivery person.

In another case of the system, the delivery personnel terminal comprises a video recording device to records images or videos of the pickup of the articles to be laundered, operation of the laundry machine, and delivery of the articles to be laundered.

In yet another case of the system, the system further receives a status from the laundry machine terminal associated with a dryer subsequent to the delivery person loading the articles to be laundered into the dryer.

In yet another case of the system, the service request comprises a selected wash mode, and wherein directing the delivery person to launder the articles comprises indicating the selected wash mode.

In yet another case of the system, the service request further comprises directions to the delivery person to iron, fold, pack, or a combination thereof, the articles.

In yet another case of the system, the system further predicts demand of the laundry machines at the self-service laundromat using a predictive model, and adjusting a pricing for the service request based on the predicted demand.

These and other embodiments are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a schematic diagram of a system for automated coordination of pickup and delivery of laundry services, in accordance with an embodiment;

FIG. 2 is a schematic diagram showing an example embodiment of a client terminal of the system of FIG. 1;

FIG. 3 is a schematic diagram showing an example embodiment of a delivery personnel terminal of the system of FIG. 1;

FIG. 4 is a schematic diagram showing an example embodiment of a laundry machine terminal of the system of FIG. 1;

FIG. 5 is a schematic diagram showing an example embodiment of a server of the system of FIG. 1; and

FIG. 6 is a flowchart of a method for automated coordination of pickup and delivery of laundry services in accordance with an embodiment.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The term “comprise” and variations of the term, such as “comprising” and “comprises,” are not intended to exclude other additives, components, integers, or steps. The terms “a,” “an,” and “the” and similar referents used herein are to be construed to cover both the singular and the plural unless their usage in context indicates otherwise. Ranges which are described as being “between” two values include the indicated values.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor, as a plurality of processors, as a multi-core and/or multi-threaded processors, or the like. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following generally relates to automated coordination of services, and more specifically, to a method and system for automated coordination of pickup, drop off, and delivery of laundry services between laundromats, customers, and delivery personnel.

As used herein, the following terms and variations thereof have the meanings given below, unless a different meaning is clearly intended by the context in which such term is used herein:
“Cleaning” and “washing” refer to the removal of contaminants (dirt, grease, food, etc.) from laundry items typically washed in a washing machine, and may include drying, dry washing, whitening, dying, sanitizing, softening, ironing, folding, mending laundry items, or any other steps that prepare laundry items for use.
“Delivery personnel” refers to one or more individuals (as the case may be) performing the delivery services described herein.
“Laundry” and “laundry Items” refer to all types of clothing, linens, towels, table linens, upholstery fabrics, protective covers, and other fabric items that can be laundered.
“Laundry Machine” refers to a washing machine or a clothes-drying machine, or a combination thereof, for use in cleaning laundry items.
“Laundromat” and “self-service laundromat” refer to an establishment comprising one or more rooms of a building that house laundry machines. Laundry machines at laundromats typically require payment in order for an individual to use the laundry machines.
A “load of laundry” refers to a collected group of laundry items which are to be cleaned, such as those items which are to be picked up, cleaned, and delivered.

Self-service laundry, coin laundry, or laundromat are a type of self-service facility where clothes can be washed by the general public, or select members of a community, without requiring the professional help of staff present on site. While the present disclosure generally refers to a self-service laundry facility, it is to be understood that any off-site laundry facility can be used; such as those closed to the public or operated by individuals or corporations.

Using self-service laundry services is generally inconvenient and/or inefficient. Generally, clients of self-service laundry services have to commute to a laundromat and physically carry their laundry items to and from a laundromat. In a laundromat, clients use a laundry-related appliance such as a washer and/or dryer. Using a laundry-related appliance typically includes the steps of loading, commencing operation, waiting for operation to cease, and unloading of the washer or dryer. Generally, doing laundry requires the user of the laundromat facility to remain present during the duration of the cleaning cycle of the laundry-related appliance in order to manually engage and monitor the appliances and to pick up cleaned items once the service is complete. The amount of time will depend on the operation cycles of the laundry machines. Commuting to the laundromat also has a monetary and time cost associated therewith.

Moreover, most consumers will generally use self-service laundromats either after common working hours on weekdays, or during weekends and holidays. As a result, the utilization of laundromats is generally not evenly distributed over time. The uneven distribution of utilization of laundromats, to some extent, causes a shortage of free laundry appliances in laundromats when the demand is high and at the same time, it leaves the same self-service laundromats underutilized or unused when the demand is low.

The present embodiments advantageously provide automated coordination of pickup and delivery of laundry services between laundromats, customers, and delivery personnel in order to allow users to receive laundry cleaning services without going to laundromats themselves. These embodiments utilize the available time of the delivery personnel and make better use of laundry machines during off-peak demand times. In this way, embodiments of the present disclosure can allow for efficient use of laundry machine availability at laundromats by easing possible shortages of laundromat facilities during peak demand hours and reduce idling times of laundromat facilities during off-peak times.

In laundromats, laundry machines generally can be equipped with laundry machine terminals. Laundry machine terminals control billing and payment services for laundry services in addition to controlling specific functions of the laundry machines. In modern laundromats, laundry machine terminals are connected to communication networks, such as the Internet, and can communicate with other computing devices over such networks. Some terminals are also able to directly communicate with nearby devices, such as a smartphone or other computing devices, wirelessly.

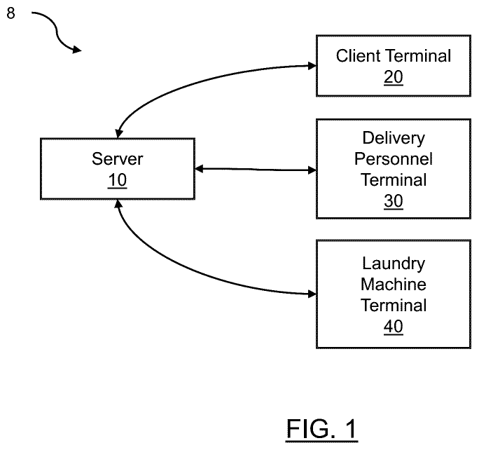

In some cases, transportation of laundry items and use of the laundromat to perform the laundry can be performed by delivery personnel. In many cases, such delivery personnel can be unassociated with the laundromat or the user. Coordinating the request for laundry services between the user, the delivery personnel, and the laundromats provides a significant challenge to manage and direct automatically. Advantageously, the present embodiments provide for the automatic coordination of picking-up soiled laundry, laundering the dirty articles by delivery personnel, paying for the laundry machines at the laundromat, and delivering the cleaned laundry back to the user. In an embodiment, a system for automated coordination of pickup and delivery of laundry services 8, as illustrated in the diagram of FIG. 1, is provided to achieve such coordination. The system 8 includes a server 10 and a client terminal 20 associated with each client, a delivery personnel terminal 30 associated with each delivery personnel, and a laundry machine terminal 40 associated with each laundry machine. Each terminal is in direct or networked communication with the server 10.

The client terminal 20 can be used by users who desire to have their articles laundered; such as members of the general public or members of a specific group. The users can make a service request and receive service status updates on the client terminal 20 via communication with the server 10. The client terminal 20 receives input from the user, where the input includes instructions for requesting the laundry services. The client terminal 20 sends client information and a client service request to the server 10, including, at least, a client terminal identifier, a pickup and/or delivery address, a quantity of articles to be laundered, and details of the requested laundry service. In some cases, a desired laundromat can be selected by the user.

The delivery personnel terminal 30 is used by the delivery personnel to receive, manage, update, and respond to laundry service requests. The delivery personnel terminal 30 can also be used to communicate with and direct the laundry machines. The delivery personnel terminal 30 can periodically, or at other intervals, send information to the server 10, including an identification associated with the delivery personnel terminal 30 and/or a location of the delivery personnel terminal 30. The delivery personnel terminal 30 can also communicate with the laundry machine terminal 40 in order to provide information about a configuration or status, such as details of the requested laundry service.

The laundry machine terminal 40 is used to send self-service laundry appliance status information to the server 10, which generally includes laundry machine location, available services, available wash modes, laundry service fees, and status of the laundry machine.

The server 10 is used to automatically coordinate activities among the client terminals 20, delivery personnel terminals 30, and laundry machine terminals 40. For example, the server 10 can communicate client requests to the delivery personnel terminals 30, can communicate information about delivery personnel to the client terminals 20, and communicate information about laundry machines associated with the laundry machine terminals 40 to the client terminals 20 and the delivery personnel terminals 30.

In some cases, the delivery personnel terminal 30 also sends a pickup report and/or a delivery report to the server 10, for example, after the pickup and/or delivery has been completed or when the status associated with a delivery personnel terminal 30 is changed. In some cases, the laundry machine terminal 40 sends a completion report to the server 10 after a laundry program cycle has been completed, or when the status of a laundry machine has changed. In some cases, the server 10 sends information about the clients to delivery personnel when a cleaning service is in progress, as described herein.

In some cases, audio-video recording devices can be used as part of the delivery personnel terminal 30 to record operations of the delivery personnel while such person performs the laundry services; for example, when picking up, dropping off, or transporting laundry items or when delivery personnel are in a laundromat.

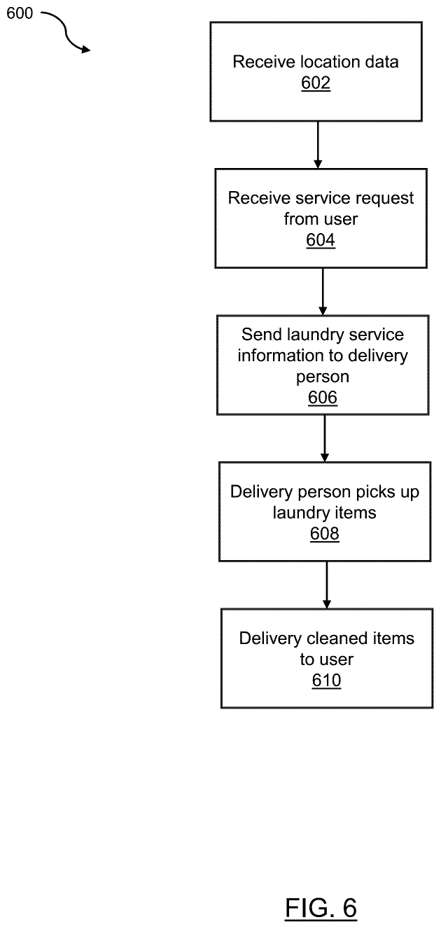

FIG. 6 illustrates a method for automated coordination of pickup and delivery of laundry services 600, in accordance with an embodiment. At block 602, the server 10 receives data with location information with respect to laundry pickup, laundry delivery, laundromats, laundry machines, and delivery personnel.

At block 604, the client terminal 20 receives a service request, which includes details of the requested laundry service, via input from a user. The client terminal 20 communicates such information to the server 10. In some cases, this information can include the user's choice of laundromat.

At block 606, the server 10 selects one of the delivery personnel and sends the laundry service information to the delivery personnel terminal 30 associated with this delivery personnel; including details of the requested service; such as a location for laundry pickup, location of laundry delivery, and details of the laundry machines to use, details of the service to be performed at such machines, and the like.

At block 608, the delivery person is directed to pick-up the user's laundry by the delivery personnel terminal 30. The delivery person takes the soiled laundry to the laundromat for cleaning as directed by the delivery personnel terminal 30. The delivery person then operates the laundry machine to clean the soiled laundry in accordance with instructions provided by the delivery personnel terminal 30; which receives such information from the client terminal 20 via the server 10. Such information includes, for example, a chosen wash mode. The operation of the laundry machine may include moving laundry items from one laundry machine to another, for example from the washing machine to the dryer. The operation may further include steps involving other operations, such as ironing laundry items or folding or packing laundry items. In some cases, personnel of a laundromat may perform some or all of the operations.

At block 610, after laundering the articles, the delivery person collects the cleaned articles and delivers the clean laundry to the location specified by the delivery personnel terminal 30 as received from the client terminal 20 via the server 10.

As part of block 602, the server 10 determines locations for laundry pick-up and delivery, for laundry machines, and for several delivery personnel. More specifically, the client places an order for the laundry pick-up and delivery service through the client terminal 20. The client can input details such as address and time for laundry pick-up, delivery address, chosen laundromat and washing mode. When placing the order for service, in some cases, the client terminal 20 can identify and recommend one or more laundromats within a threshold distance of the location for the client. In some cases, the client terminal 20 can determine and may also recommend off-peak times for laundry pick-up to the client by means of discounts, coupons or other incentives so as to improve the utilization of laundry machines or the free time of delivery personnel during off-peak times. The laundry fees and service charge constitute the total amount of the bill for the client and the order generated becomes valid until payment for the bill is completed.

Before placing the order, the client can register to create an account through the client terminal 20 to provide necessary client information such as the identification, address, payment details, such as credit card number, and so forth. The client can also add funds to the registered account for later payments.

As part of block 606, the server 10 can send information about the address for pick-up and the chosen laundromat to the delivery personnel terminal 30. The valid order together with the time and address for laundry pick-up is assigned to the terminal of a selected delivery person. Preferably, when the delivery person accepts a service request and follows the service instruction, the delivery person may be required to wear and use an audio-video recording device to keep a record of his/her actions. Meanwhile, the terminal of the delivery personnel can also keep track of the real-time location of the delivery person throughout the execution of the service.

As part of block 608, the delivery person takes the soiled laundry to the self-service laundromat selected by the server 10 for cleaning. The delivery person puts the articles into the laundry machine, enters the corresponding order through the delivery personnel terminal 30 to obtain information about the washing mode, and operates the machine accordingly. The operation of the laundry machine can be performed automatically, through the delivery personnel terminal 30 or it can be done manually by the delivery person on the machine itself. In many cases, the delivery person may scan a QR code on, or in proximity to, the laundry machine to identify the correct laundry machine. The delivery person can then process the payment transaction for the laundry service using the payment method previously selected by the client, and based on obtained washing mode details, starts the cleaning of the laundry.

The obtained information about the input washing mode can also be used by the delivery personnel terminal 30. The delivery personnel can compare details with the laundry machine settings to identify mistakes and to take necessary correction steps required, if any. After a cleaning cycle starts, the delivery person may choose to wait in place or take more orders. If the latter one is taken, the delivery personnel terminal 30 shall remind the delivery personnel to return to collect the laundry in a timely manner, for example, before the cleaning is completed to prevent the loss of the property, and to minimize delayed delivery of laundered articles. Alternatively, the server 10 may allocate another delivery person to go to the laundromat to collect the laundry and return it to the user. Similarly, in some cases, when a delivery person is unable to complete the service, the server 10 may allocate another delivery person to complete all remaining steps of the service.

As part of blocks 608 and 610, the delivery personnel terminal 30 directs collection of the clean laundry and to deliver this laundry to the location appointed by the client terminal 20. After collecting the laundered articles, the delivery person will deliver them to the delivery address in the order. The delivery address for delivery can be the same as the pick-up address or can be a different address selected by the user. After the delivery is completed, the user and/or the delivery person can confirm the completion of the service, after which a corresponding service fee will be transferred to the delivery personnel terminal 30.

In most cases, the server 10 selects the most appropriate delivery person, and/or the most appropriate laundromat, based on, for example, (1) distances between the pick-up location, drop-off location, delivery person location, and laundromat location, (2) loads required and capacity of the laundromat, and (3) other preferences and factors. After selecting the most appropriate delivery person, the server 10 sends information about the location of laundry pickup and delivery to the delivery personnel terminal 30.

In a preferred embodiment, the server 10 can provide information about the service charge to the user and verify valid payment from the user before sending the location of pickup and delivery to the delivery person.

The client terminal 20 receives details of the laundry service request from the user, such as a choice of laundromat and washing mode. The client terminal 20 then sends such details to the server 10. Once the server 10 selects an appropriate pair of laundry machine terminal 40 and delivery personnel terminal 30, it will send details of its selection, such as details of a specific laundry machine terminal 40 and configuration details for the selected machine to the delivery personnel terminal 30.

The delivery personnel terminal 30 receives laundry service instructions from the server 10 and displays or otherwise communicates such instructions to the delivery personnel and/or the laundry machine terminal 40. For example,
the location of the client,
what laundry items to pick up,
which laundromat to bring the laundry items,
information about loading the laundry items to the self-service laundry machine,
configuring the laundry machine
executing the laundry service cycle,
picking up the laundry items from one laundry machine and loading it into another,
picking up laundry items after the laundry service cycle is completed,
bringing the laundry items back to the location requested by the client terminal 20, and
delivering the laundry items back to the client.

In most cases, the delivery person can also make a recording of the laundry pickup, carrying, and loading by an audio-video recording device. Delivery personnel are equipped with such audio-video recording devices to record their operations. The video recordings can be used to help investigate possible complaints from the customer when a damage to the customer's articles is identified or reported. Such recordings can also be relied on to optimize and/or to rule out the possibility of deliberate sabotage.

In some cases, the server 10 provides information about other clients to the delivery person when a laundry service is in progress. Such details can be used to optimize the allocation of resources.

The client terminal 20 can be any electronic device with a wireless or wired communication capability, memory, and processing functions such as smart phones, tablets, intelligent wearable devices and so forth.

The delivery personnel terminal 30 can be any portable electronic device with wireless communication capability, memory, and processing functions that can be transported by delivery personnel, such as smart mobile phones, tablets, intelligent wearable devices, vehicle mobile devices, and so forth.

The laundry machine terminal 40 can be any electronic devices with wireless communication functions which are integrally incorporated into or are in proximity to and/or electronic communication with one or more laundry machines.

The client terminal 20, delivery personnel terminal 30, and laundry machine terminal 40, each include memory and at least one processing unit for receiving, storing, and executing service instructions and information needed to perform the functions described herein.

In some cases, service instructions and information are received from and sent to several applications, such as smartphone applications or other software, which are stored in the memory of the client terminal 20, delivery personnel terminal 30, and/or laundry machine terminal 40. In other cases, service instructions can be received by and sent to a web browser or other general purpose software application which includes a user interface as part of the client terminal 20 or delivery personnel terminal 30.

The server 10 communicates with the client terminal 20, delivery personnel terminal 30, and laundry machine terminal 40. The connections can be either direct connections or over networked connections, such as the internet. The delivery personnel terminal 30 can optionally be in communication with the laundry machine terminal 40 to send configuration commands to the machine or to receive status updates from the laundry machine terminal 40.

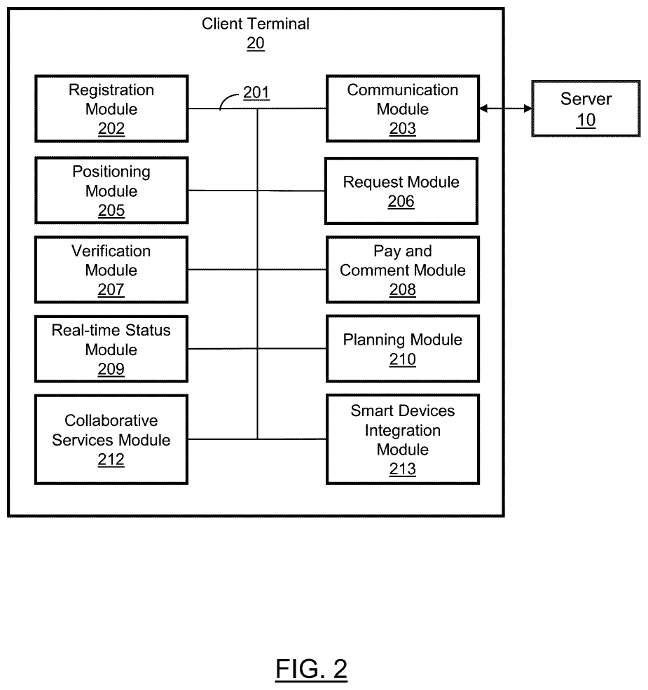

FIG. 2 depicts a block diagram of an example implementation of conceptual modules executed on the client terminal 20. As shown in FIG. 2, the client terminal 20 can include a client communication module 203, a client registration module 202, a client positioning module 205, a client request module 206, a client verification module 207, a client pay and comment module 208, a client real-time status module 209, a client planning module 210, a client collaborative service module 212, and a client smart devices integration module 213.

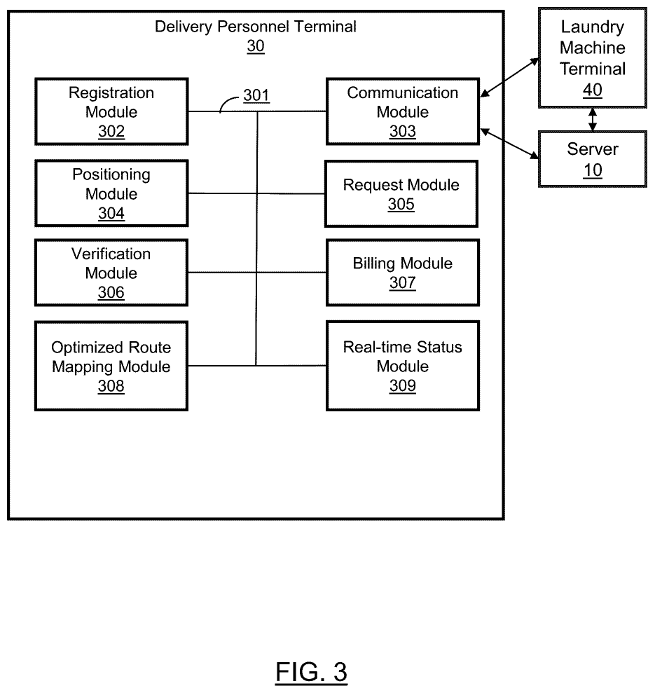

FIG. 3 depicts a block diagram of an example implementation of conceptual modules executed on the delivery personnel terminal 30. As shown in FIG. 3, the delivery personnel terminal 30 can comprise a delivery registration module 302, a delivery communication module 303, a delivery positioning module 304, a delivery request module 305, a delivery verification module 306, a delivery billing module 307, a delivery optimized route mapping module 308, and a delivery real-time status update module 309.

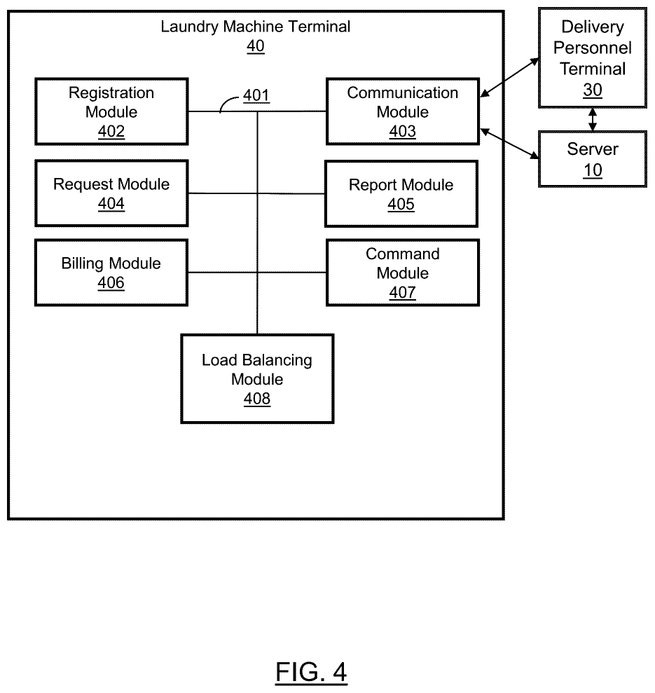

FIG. 4 depicts a block diagram of an example implementation of conceptual modules executed on the laundry machine terminal 40 of the system 8. The laundry machine terminal 40 can comprise a laundry communication module 403, a laundry registration module 402, a laundry request module 404, a laundry report module 405, a laundry billing module 406, a laundry command module 407, and a laundry load balancing module 408.

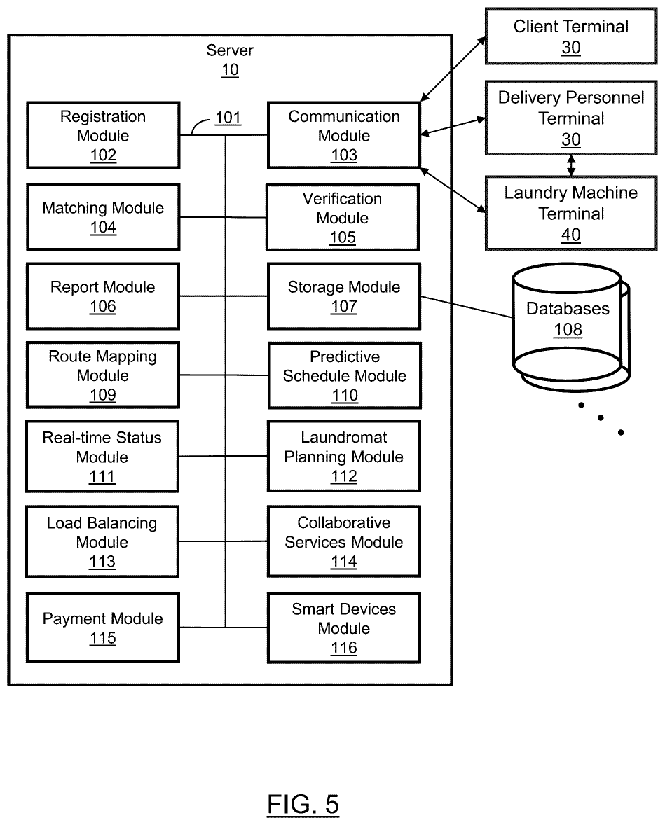

FIG. 5 depicts a block diagram of an example implementation of conceptual modules executed on the server 10. As shown in FIG. 5, the server 10 can comprise a server communication module 103, a server registration module 102, a sever matching module 104, a server verification module 105, a server report module 106, a server storage module 107 (which may be in communication with one or more external databases 108), a server route mapping module 109, a predictive schedule module 110, a server real-time status module 111, a laundromat planning module 112, a server load balancing module 113, a server collaborative services module 114, a server payment module 115, and a server smart devices module 116

The server 10 communicates with the client terminal 20, the delivery personnel terminal 30, and the laundry machine terminal 40.

The client registration module 202 enables clients to register as users. It sends the registered information including client terminal 20 identification, contact number, chosen washing mode, and the like, to the server 10 registration module 102.

The delivery registration module 302 enables the delivery personnel to register as users. It sends the registered information including delivery personnel's terminal ID, identification data, contact number and other information to the server 10 registration module 102 of the server 10.

The laundry registration module 402 enables the registration of the laundry machines. It sends the registered information such as laundry machine location, serial number, washing mode and billing rules to the registration module 102 of the server 10.

When the server 10 receives registration information about clients, delivery personnel, or laundry machines, the server 10 registration module 102 determines if the registrations are valid, and sends such feedback to each terminal, and sends the data of complete registrations to the server 10 storage module 107. Validation of registration may include use of data pattern validation or generating one-time verification code that will be directly sent to the user's registered phone number to verify if the user has possession of the registered phone number.

The server storage module 105 can maintain order queue data, user data, delivery personnel data, laundromat data, or other datasets as required. The server storage module 105 may also use one or more external databases 108.

The client positioning module 205 obtains the client location details or address of the client for laundry pick-up and delivery. The location or address of laundry pick-up and delivery can be different from each other for a single request. The client positioning module 205 sends the client location details to the client communication module 203, which in turn sends client location details to the server 10. The delivery positioning module 304 obtains the current location of each of the delivery personnel and sends it to the delivery communication module 303, which in turn sends the current location of each of the delivery personnel to the server 10. The client positioning modules 205 and the delivery positioning 304 module can adopt any suitable positioning approach, such satellite positioning. In alternative embodiments, the client positioning modules 205 and the delivery positioning module 304 can use Wi-Fi, telecommunication base stations or other means to track the location of client terminal and delivery personnel terminal 30.

The client request module 206 sends information about clients to the server 10, which can include identification of the client terminal 20, locations for laundry pick-up and delivery, time for pick-up, chosen laundromats, washing mode, and the like. The delivery request module 305 sends information about delivery personnel to the server 10, which can comprise terminal ID and current location of the delivery personnel. The laundry request module 404 sends information about laundry machine terminal, such as terminal identification and the current state of laundry machines associated with the laundry machine terminal 40 to the server 10.

The server optimized route mapping module 109 in collaboration with the delivery optimized route mapping modules 308 of the delivery personnel terminals 30, determines the most efficient routes for delivery personnel for picking up and dropping off laundry items and travel between clients and laundromats. The server optimized route mapping module 109 may rely on the delivery optimized route mapping modules 308 to optimize a route; however, the server optimized route mapping module 109 maintains control over the determination of the most efficient route. The delivery optimized route mapping modules 308 may take over the control of determination of the route if the delivery terminal 30 operates for a pre-configured minimum amount of time without a functioning network communication with the server 10.

The server optimized route mapping module 109 may rely on several input data sources to determine the most efficient routes for delivery personnel and as a result may improve several factors. For example, the route mapping module 109 may reduce transit times, minimize fuel costs, or improves likelihood of timely service. The input data sources of the server optimized route mapping module 109 may include real-time GPS data, a collection of dynamic data sources, and a collection of static data sources. The static data sources may include data points such as the address of customers, laundromats, traffic patterns, road closures, and historical routing efficiency data. The dynamic data sources may include collection of real-time laundry request data, current workload of laundromats, and a prediction of service completion times. The real-time GPS data is acquired from delivery personnel terminals 30 and client terminals 20 using delivery positioning modules 304 and client positioning modules 205. The acquisition of the real-time GPS data is performed through client communication module 203, delivery communication module 303, and server communication module 103.

The server optimized route mapping module 109 may have integration with external services to function. For example, the mapping module 109 may be integrated with external geographic information systems (GIS) or mapping and routing services to acquire accurate geolocation data or to receive routing services, or to receive real-time traffic data to determine or update or optimize routes or avoid roads with heavy traffic or road closures.

The server optimized route mapping module 109 may use several algorithms including algorithms that are improved with machine learning (ML) models or artificial intelligence (AI) techniques. For example, the route mapping module 109 may use shortest path algorithms, travelling salesman problem (TSP) solvers, or machine learning predictive models. For route generation, the route mapping module 109 may compute an optimal route based on a combination of real-time and predictive data. In cases where a new order is added or an unexpected event like a road closure occurs, the route mapping module 109 may perform a dynamic re-routing by re-evaluating the combination of real-time and predictive data. In cases of route determination for delivery personnel who handle multiple service orders concurrently, the route mapping module 109 determines the sequence of pickups and drops to optimize or improve efficiency. In all cases, the route mapping module 109 identifies and maintains estimated times for pick-up, laundry completion, and drop-off based on the overall schedule of planned routes. Furthermore, the route mapping module 109 relies on feedback loop of actual data collection which may include actual data such as actual route taken, time taken for each route, or any delays or logged issues faced. In cases of route determination with Al and ML models, the route mapping module 109 may use the collected actual data to refine or re-train existing models such as a collection of predictive models to improve route determination or optimization over time.

The predictive laundry schedule module 110 of the server 10 may provide a predictive approach, which forms a predictive dataset. This dataset may include a collection of historical data of clients, delivery personnel, or laundromats. This predictive dataset may include ordering patterns of clients, laundromat usage patterns, delivery personnel previous schedules and performance, and other relevant metrics. The predictive data set is used to predict patterns of orders and to identify required resources to fulfill them. For example, it may include pre-schedule pick-up times, even before a request is made. This predictive approach can streamline the services by potentially automating some steps or preparing reserved resources in advance, ensuring faster and more efficient service delivery.

The predictive laundry schedule module 110 may rely on several input data sources to form the predictive dataset; for example, it may use client data such as a history of laundry service requests, service preferences, feedbacks, and other behavioral patterns. The predictive module 110 may use delivery personnel data such as historical routes, delivery times and pervious performance, or patterns of availability to render services. The predictive module 110 may use historical data of laundromats, such as usage patterns, laundry machine utilization patterns, previous peak hours, previous maintenances or planned maintenance schedules, and customer feedback. The predictive module 110 can also use external data sources and services such as weather services to predict laundry requests based on weather forecasts or to obtain previous weather data and incorporate weather data into the predictive dataset. Another example of external data sources is calendar data sources which may be required to identify public holidays, local events, or other significant days that may influence laundry service request patterns.

The predictive laundry schedule module 110 may use several algorithms, including algorithms that are improved with machine learning (ML) models or artificial intelligence (AI) techniques. For example, the predictive schedule module 110 may use time series forecasting techniques, classification models, clustering models, or reinforcement learning models.

To form a predictive schedule or dataset, the predictive schedule module 110 may forecast demand by predicting when and where a high demand for laundry services would exist along with a likelihood of forecasted demand. The predictive schedule module 110 may provide means for behavioral prediction of users by identifying anticipated preferences of each individual user for wash modes and other service details based on past data and behavior. The predictive schedule module 110 may further predict operation patterns, for example, it may provide a forecast of machine breakdowns or maintenance needs at laundromats based on historical data. The predictive schedule module 110 may be used for adoption of a dynamic pricing model for services or to plan for promotional offices which may include dynamic service fees paid by customers, monetary compensation paid to delivery personnel, and service fees paid to laundromats. Such models may rely on predicted demand or other relevant data.

The server optimized route mapping module 109 may rely on several approaches to form data feedback loops and optimize the performance of predictions. For example, a continuous assessment of the model's accuracy and relevance can be used for model evaluation. Furthermore, real-time adjustments using real-world actual results may be used to adapt and improve the predictive models continuously.

The server real-time laundry status update module 111 in collaboration with the client real-time status update module 209 and the delivery real-time status update module 309 can allow customers and delivery personnel to have progress updates of their current services and upcoming prediction of next service steps in a close to real-time manner.

The server real-time laundry status update module 111 may rely on several input data sources to determine the status of current services and upcoming predictions. The server real-time status module 111 may rely on collected data from laundry machines and laundry machine sensors. For example, in modern laundry machines with IoT (Internet of Things) capabilities, sensors can detect when a load starts, how a laundry cycles progresses, and when it is going to be completed. Factors such as detecting presence of detergents, water temperature, water levels, and cycle phases are commonly detected using sensors. The use of sensors is especially important when a laundry cycle includes adjustments of water temperature, steam generation, or drying cycles temperature. The server real-time status module 111 may rely on input from delivery personnel as well. For example, delivery personnel may manually update the status of a task through their associated delivery personnel terminal 30, for example to select their current status from a pre-identified list of steps such as “en route to pick up”, “picked up”, “dropped off”. In some cases, the delivery personnel may manually update the status of a laundry machine or the status of other tasks at a laundromat. The server real-time status module 111 may further rely on real-time GPS data acquired from the client positioning module 205 of client terminal 20 or from the delivery positioning module 304 of the delivery personnel terminal 30.

The server real-time laundry status update module 111 may include a status data processor component which can interpret raw data from laundry sensors and and/or manual inputs for delivery personnel to identify status updates, such as “Washing”, “Rinsing”, “Spinning”, “Drying”, for a laundry machine. The operation of the server status module 111 may involve collection and aggregation of data for each single order to provide a coherent view of progress. The server status module 111 may be configured to send near real-time push notifications containing service status updates to the client terminal 20 or the delivery personnel terminal 30.

The laundromat planning module 112 of the server 10 may provide insightful planning information regarding popular times, estimated wait times, and typical visit durations at laundromats to customers through the client planning module 210, and in some cases to delivery personnel as well. This planning information may assist users in choosing optimal times of the day or week to send schedule their requested laundry services.

The laundromat planning module 112 may rely on several data points to identify regular traffic pattern and best available time-slots; for example the planning module 112 may rely on the current or historical data of laundry machine or it may rely on IoT sensors installed at laundromat entrances/exits to count the number of visitors

The laundromat planning module 112 may use several algorithms to analyze data sets. For example, the planning module 112 may use time-series analysis to determine popular times by analyzing patterns over periods of time such as days, weeks, and months. Furthermore, it may use queue theory models to estimate wait times based on the number of machines, average wash cycle times, and incoming user demands. In some cases, Al and ML algorithms such as regression or time-series forecasting, can be used to predict popular times and potential wait times based on historical data.

The server load balancing module 113, in collaboration with the laundry load balancing modules 408 of the laundry machine terminals 40, may balance utilization of all available resources across multiple laundromats to provide better service to customers, or to ensure efficiency, or to ensure that no single laundromat is overwhelmed with too many orders. Balancing the utilization load of laundromats may contribute to smooth operation of each laundromat It may also reduce wait times and it may help with offering a consistent quality of service in general.

In order to balance the utilization of all available resources, the load balancing module 113 may use several datasets. For example, the load balancing module 113 may use the queue of orders which may include details such as a list of incoming laundry orders before they are assigned to a particular laundromat. Furthermore, the load balancing module 113 may use real-time status of each laundromat, including current load (i.e., current queue of assigned services), the number of available machines, laundry services in progress, estimated wait times, or pre-identified details of each laundromat operation such as working hours, laundry machine types, or laundry machine capacities.

The load balancing module 113 may use several approaches to balance utilization of all available resources across multiple laundromats. For example, a dynamic assignment approach may be used by the load balancing module 113 to assign orders to laundromats based on the real-time load of a sub-set of laundromats, the proximity to the customer to a sub-set of laundromats, or based on specific needs of fulfilling the order. The load balancing module 113, may further prioritize orders based on subscription status of a customer, identified urgency of rendering service, or any other condition that may negatively affect an optimal balance of utilization. The load balancing module 113 may use Al or ML algorithms to predict the incoming load for specific time slots or days using historical data and trends or to perform the balancing of utilization. In some cases, a pre-emptive load balancing approach may be used, especially when an ML and Al model is being used.

The service collaborative services module 114 and the client collaborative service module 212 enable offerings of ancillary services such as ironing, dry cleaning, or mending. The offer of ancillary services may include a combination of services such as “wash and iron”, “wash and repair”, or “dry-clean and iron”.

The server smart devices integration module 116 and the client smart devices integration module 213 can allow communication with a smart device, such as smart laundry baskets. A smart laundry basket can be used by a customer to help with scheduling laundry services; for example, when a smart laundry basket is full, the smart laundry basket can notify the server 10, the client terminal 20, or the delivery personnel terminal 30, and subsequently, a laundry pickup may be suggested or scheduled.

The client verification module 207 verifies the received protocols and other information from the server 10 and gives feedback of such verification to the server 10. The delivery verification module 306 verifies the received protocols and other information from the server 10 and gives feedback of such verification to the server 10. The server verification module 106 verifies the received protocols and other information from the client terminal 20 and delivery personnel terminal 30 and maintains such verification which may be used for any suitable purpose, for example to identify issues, to take corrective actions, or to rollout configuration updates on the server 10, client terminal 20, or delivery terminal 30. The pay and comment module 208 enables the client to pay for a service order and comment on the service upon completion of services. The total amount of a bill for a service order typically consists of two parts, a service charge for laundry pick-up and delivery, and a laundry fee. The delivery billing module 307 is used to calculate the travelling distance of the delivery personnel based on his/her route of movement and the corresponding service charge using a preset unit price. The delivery billing module 307 then sends the data of the delivery personnel's travelling route, distance, and service charge, to the server 10, through the delivery communication module 303, which in turn sends client location details to the server 10. In cases where a pre-registered account is associated with a client, the automated payment module 115 may be configured to deduct the total amount of the bill from the pre-registered account, without manual intervention of the user. This automatic deduction may be configured to be performed at various stages, for example, when a laundry machine is started, or when the clean laundry items are delivered, or at the end of a billing cycle such as a monthly billing cycle.

The laundry billing module 406 is used to calculate fees charged for use of one or more laundry machines at laundromats. The fees include a set of pre-determined laundry billing rules for using the laundry resources such as specific machines and washing modes. The laundry billing rules can include details such as different prices for the load size, type of service, location of service, and time of service. For each execution of a laundry cycle on a laundromat laundry machine, the laundry billing module 406 uploads the data of the billing rules, chosen wash modes, and the corresponding laundry fees to the server 10 through the laundry communication module 403, which in turn sends such details to the server 10.

The laundry machine terminal 40 is preferably able to collect information about the status of laundry machines with which it is associated via a wired or wireless connection. The laundry machine status information may include details such as laundry load washing status and remaining washing time. Such status information is preferably collected in real time by the laundry report module 405 and is provided to the server 10 through the laundry communication module 407 of the laundry machine terminal 40. The server 10 report module 106 can send the status information to the client terminal 20.

The delivery personnel terminal 30 communicates with the laundry machine terminal 40, through the delivery communication module 303, to send information and commands about the washing mode. Once the laundry machine terminal 40 receives information and commands about the washing mode, the laundry machine terminal 40 through the command module 407 sends instructions to the washing machine to start a laundry cleaning procedure.

In some cases, the laundry machine will be enabled for both washing and drying laundry, while in other cases a separate drying step will be performed by the delivery personnel after the load of laundry is washed, which may involve moving the wet, washed laundry to a separate machine for drying by the delivery personnel.

The present embodiments improve the usage of existing self-service laundry facilities. By providing a laundry pick-up and delivery service, the use of self-service laundromats is made easier for clients who are far from laundromats or who have difficulty using laundromats. The present embodiments can also help balance the supply and demand for laundry resources by scheduling of services during off-peak hours and by redirecting service requests to underutilized laundromats. Thus, some of the originally idling laundry machines are likely to be put into use during off-peak hours which may eventually contribute to a cost reduction for business owners.

Additionally, by scheduling the execution of client's order for the service, the present embodiments may also create more jobs for those engaged in part-time work during their available time. The delivery personnel can drive or ride bicycles to provide the present service in addition to performing it on foot, and that the personnel could live in the same building as the client, or otherwise allowed to enter the location for laundry pick-up and delivery.

Without the laundry delivery and pickup service, the customers would have to go to the laundromats in person only when they have the time to do so. If they are at work during daytime, the machines are more likely to be idle compared with weekends and holidays (possible peak time). But with the service of pickup and delivery, they can order such services even while they are occupied at work.

The above description depicts several implementations, but it is not intended to limit the scope of the invention to the example embodiments. Various modifications to the preferred embodiment are readily apparent to those skilled in the art and the general principles herein can be applied to other embodiments which are considered to be within the scope of the invention as defined by the appended claims.

1. A method automated coordination of pickup and delivery of laundry services for laundering articles at a self-service laundromat, the method comprising:
receiving a service request from a client terminal, the service request comprising a laundry pickup address and a laundry delivery address;
determining a delivery person to respond to the service request;
directing the delivery person to pickup the articles to be laundered by communicating the service request to a delivery personnel terminal associated with the delivery person;
receiving a status from a laundry machine terminal associated with a laundry machine subsequent to the delivery person loading the articles to be laundered into the laundry machine;
directing the delivery person to collect the laundered articles by communicating the status of the laundry cleaning to the delivery personnel terminal when the status indicates the cleaning is complete; and
directing the delivery person to deliver the laundered articles to the laundry delivery address.

2. The method of claim 1, further comprising receiving a further service request, and wherein while the laundry machine is operating, communicating the further service request to the delivery person.

3. The method of claim 1, wherein the delivery personnel terminal comprises a video recording device to records images or videos of the pickup of the articles to be laundered, operation of the laundry machine, and delivery of the articles to be laundered.

4. The method of claim 1, further comprising receiving a status from the laundry machine terminal associated with a dryer subsequent to the delivery person loading the articles to be laundered into the dryer.

5. The method of claim 1, wherein the service request comprises a selected wash mode, and wherein directing the delivery person to launder the articles comprises indicating the selected wash mode.

6. The method of claim 1, wherein the service request further comprises directions to the delivery person to iron, fold, pack, or a combination thereof, the articles.

7. The method of claim 1, further comprising predicting demand of the laundry machines at the self-service laundromat using a predictive model.

8. The method of claim 7, further comprising adjusting a pricing for the service request based on the predicted demand.

9. A system for automated coordination of pickup and delivery of laundry services for laundering articles at a self-service laundromat, the system comprising a server terminal, a client terminal, a laundry machine terminal, and a delivery personnel terminal, each terminal comprising one or more processors in communication with a data storage, the data storage of the server terminal comprising instructions for the one or more processors to execute:
receiving a service request from a client terminal, the service request comprising a laundry pickup address and a laundry delivery address;
determining a delivery person to respond to the service request;
directing the delivery person to pickup the articles to be laundered by communicating the service request to a delivery personnel terminal associated with the delivery person;
receiving a status from a laundry machine terminal associated with a laundry machine subsequent to the delivery person loading the articles to be laundered into the laundry machine;
directing the delivery person to collect the laundered articles by communicating the status of the laundry cleaning to the delivery personnel terminal when the status indicates the cleaning is complete; and
directing the delivery person to deliver the laundered articles to the laundry delivery address.

10. The system of claim 9, the system further receives a further service request, and wherein while the laundry machine is operating, communicates the further service request to the delivery person.

11. The system of claim 9, wherein the delivery personnel terminal comprises a video recording device to records images or videos of the pickup of the articles to be laundered, operation of the laundry machine, and delivery of the articles to be laundered.

12. The system of claim 9, the system further receives a status from the laundry machine terminal associated with a dryer subsequent to the delivery person loading the articles to be laundered into the dryer.

13. The system of claim 9, wherein the service request comprises a selected wash mode, and wherein directing the delivery person to launder the articles comprises indicating the selected wash mode.

14. The system of claim 9, wherein the service request further comprises directions to the delivery person to iron, fold, pack, or a combination thereof, the articles.

15. The system of claim 9, the system further predicts demand of the laundry machines at the self-service laundromat using a predictive model.

16. The system of claim 15, wherein the system further adjusts a pricing for the service request based on the predicted demand.
